(19) United States
(12) Patent Application Publication
(10) Pub. No.: US 2024/0059943 A1
(43) Pub. Date: Feb. 22, 2024

(54) HEAT-CURING EPOXY RESIN COMPOSITION SUITABLE FOR PRE-CURING PROCESSES WITHOUT ADDITIONAL METAL JOINING TECHNIQUES

(71) Applicant: SIKA TECHNOLOGY AG, Baar (CH)

(72) Inventors: Dusko PARIPOVIC, Zürich (CH); Dominique GALLO, Adlikon bei Regensdorf (CH); Antonio VOCI, Zürich (CH)

(73) Assignee: SIKA TECHNOLOGY AG, Baar (CH)

(21) Appl. No.: 18/273,210

(22) PCT Filed: Mar. 22, 2022
(86) PCT No.: PCT/EP2022/057504

§ 371 Date: Jul. 19, 2023

(30) Foreign Application Priority Data
Apr. 1, 2021 (EP) 21166715.9

(51) Int. Cl. C09J 163/00; C08G 59/24; C08G 59/22; C08G 59/40; C08G 59/68; C09J 11/08; C09J 5/06; B32B 37/12; B32B 15/08

(52) U.S. Cl. CPC C09J 163/00; C08G 59/245; C08G 59/226; C08G 59/4035; C08G 59/686; C09J 11/08; C09J 5/06; B32B 37/12; B32B 15/08; C09J 2463/00; C09J 2475/00; B32B 2255/26; B32B 2307/54; B32B 2307/542; B32B 2307/748

(57) ABSTRACT

Heat-curing epoxy resin compositions containing a curing agent in the form of a mixture of aromatic dicarboxylic dihydrazide with a dihydrazide chosen from the group consisting of glutaric dihydrazide, adipic dihydrazide, pimelic dihydrazide, 8,12-eicosadienedioic acid-1,20-dihydrazide and 4-isopropyl-2,5-dioxoimidazolidine-1,3-di(propionohydrazide). The epoxy resin compositions are particularly suitable for automotive body-in-white bonding, where after induction pre-curing without additional metal joining techniques the pre-cured adhesives are cured again in a further step at temperatures of around 180° C.

### TECHNICAL FIELD

The invention relates to the field of thermosetting one-component epoxy resin compositions, especially for use as bodywork adhesive.

### PRIOR ART

An important field of use of thermosetting one-component epoxy resin compositions is in vehicle construction, especially in bonding in bodywork construction. After the application of the epoxy resin composition, the bodywork is heated in the cathodic electrocoating oven, as a result of which the thermosetting one-component epoxy resin composition is also cured. Nowadays, the epoxy adhesives mentioned are used exclusively in combination with other metal joining techniques such as welding or riveting, since the components bonded would not withstand mechanical stress prior to curing, for example when being transported to the cathodic electrocoating oven. Partial curing of the epoxy adhesives applied upstream of the cathodic electrocoating oven, for example by means of induction heating, would be a rapid and inexpensive alternative to the costly and inconvenient thermal and mechanical metal joining techniques that have been mentioned. However, such partial curing operations have the disadvantage that, typically, only limited energy input into the epoxy adhesives is possible, curing progresses too little, and low mechanical strength is obtained. Especially at the high temperatures of 180° C. in the cathodic electrocoating oven, adhesion of conventional partly cured epoxy adhesives fails without additional metal joining techniques before they reach the final curing.

### SUMMARY OF THE INVENTION

It is therefore an object of the present invention to provide thermosetting one-component epoxy resin compositions that have sufficient adhesion without additional metal joining techniques after preliminary curing, especially 60 seconds at 180-200° C., preferably 180° C., in the case of further heating to 180° C.

This object was surprisingly achieved by a thermosetting one-component epoxy resin composition as claimed in claim 1. This epoxy resin composition has particularly good usability as a one-component thermosetting adhesive, especially as a thermosetting one-component bodywork adhesive in motor vehicle construction.

### WAYS OF EXECUTING THE INVENTION

The present invention relates to thermosetting one-component epoxy resin compositions comprising:
a) at least one epoxy resin A having an average of more than one epoxy group per molecule;
b) at least one curing agent B1 for epoxy resins, where the curing agent B1 is an aromatic dicarboxylic dihydrazide, especially isophthalic dihydrazide and/or terephthalic dihydrazide, preferably isophthalic dihydrazide; and
c) at least one curing agent B2 for epoxy resins, where the curing agent B2 is a dihydrazide selected from the group consisting of glutaric dihydrazide, adipic dihydrazide, pimelic dihydrazide, 8,12-eicosadienedioic acid 1,20-dihydrazide and 4-isopropyl-2,5-dioxoimidazolidine-1,3-di(propionohydrazide), especially adipic dihydrazide.

The weight ratio of curing agent B1 to curing agent B2 (B1/B2) is 0.15-20.

In this document, the use of the term “independently” in connection with substituents, radicals or groups should be interpreted such that the substituents, radicals or groups having the same designation in the same molecule may occur simultaneously with different meanings.

The prefix “poly” in substance names such as “polyol”, “polyisocyanate”, “polyether” or “polyamine” in the present document indicates that the respective substance, in a formal sense, contains more than one of the functional groups that occur in its name per molecule.

In the present document, “molecular weight” is understood to mean the molar mass (in grams per mole) of a molecule. “Average molecular weight” is understood to mean the number-average molecular weight M n of an oligomeric or polymeric mixture of molecules, which is typically determined by means of GPC against polystyrene as standard.

A “primary hydroxyl group” refers to an OH group bonded to a carbon atom having two hydrogens.

In the present document, the term “primary amino group” refers to an NH₂ group bonded to one organic radical, while the term “secondary amino group” refers to an NH group bonded to two organic radicals which may also together be part of a ring. Accordingly, an amine having one primary amino group is referred to as “primary amine”, one having a secondary amino group correspondingly as “secondary amine”, and one having a tertiary amino group as “tertiary amine”.

In the present document, “room temperature” refers to a temperature of 23° C.

The epoxy resin A having an average of more than one epoxy group per molecule is preferably a liquid epoxy resin or a solid epoxy resin. The term “solid epoxy resin” is very well known to a person skilled in the art of epoxies and is used in contrast to “liquid epoxy resins”. The glass transition temperature of solid resins is above room temperature, meaning that they can be comminuted at room temperature to give free-flowing powders.

Preferred epoxy resins have the formula (II)

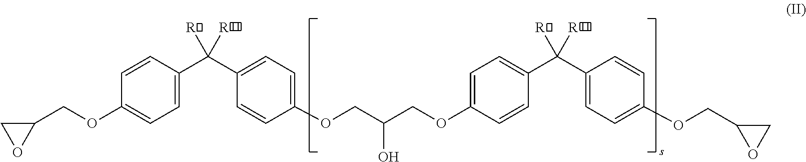

The substituents R [symbol] R [symbol] here are independently either H or CH₃.

In solid epoxy resins, the index s has a value of >1.5, especially of 2 to 12.

Such solid epoxy resins are commercially available, for example from Dow or Huntsman or Hexion.

Compounds of the formula (II) having an index s of 1 to 1.5 are referred to as semisolid epoxy resins by the person skilled in the art. For this present invention, they are likewise considered to be solid resins. However, preferred solid epoxy resins are epoxy resins in the narrower sense, i.e. where the index s has a value of >1.5.

In liquid epoxy resins, the index s has a value of less than 1. Preferably, s has a value of less than 0.2.

Preference is thus given to diglycidyl ethers of bisphenol A (DGEBA), of bisphenol F, and of bisphenol NF. Such liquid resins are available, for example, as Araldite® GY 250, Araldite® PY 304, Araldite® GY 282 (Huntsman) or D.E.R.™ 331 or D.E.R.™ 330 (Dow) or Epikote 828 (Hexion).

Further suitable epoxy resins A are what are called epoxy novolaks. These especially have the following formula:

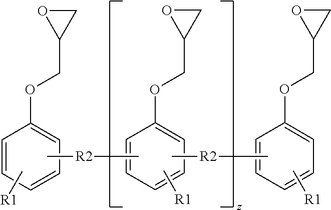

with R2=

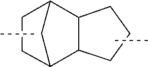

or CH₂ , R1=H or methyl and z=0 to 7.

More particularly, these are phenol or cresol epoxy novolaks (R2=CH₂).

Such epoxy resins are commercially available under the EPN or ECN and Tactix® trade names from Huntsman or from the D.E.N.™ product series from Dow Chemical.

The epoxy resin A is preferably an epoxy resin of the formula (II), especially a liquid epoxy resin of the formula (II).

In a particularly preferred embodiment, the thermosetting one-component epoxy resin composition contains both at least one liquid epoxy resin of the formula (II) with s<1, especially less than 0.2, and at least one solid epoxy resin of the formula (II) with s>1.5, especially from 2 to 12.

The proportion of the epoxy resin A is preferably 10-60% by weight, especially 30-60% by weight, especially 40-55% by weight, based on the total weight of the epoxy resin composition.

It is further advantageous when 50-100% by weight, especially 80-100% by weight, of the epoxy resin A is an aforementioned liquid epoxy resin.

It is further advantageous when 0-30% by weight, especially 0-20% by weight, more preferably 5-15% by weight, of the epoxy resin A is an aforementioned solid epoxy resin.

The composition of the invention also contains at least one curing agent B1 for epoxy resins, where the curing agent B1 is an aromatic dicarboxylic dihydrazide. It is especially isophthalic dihydrazide and/or terephthalic dihydrazide, preferably isophthalic dihydrazide.

Suitable dihydrazides are commercially available, for example, from Otsuka Chemical Co., Ltd under the Ajicure® trade name (from Ajinomoto Fine-TechnoCo., Inc.) and under the Technicure® trade name (from A&C Catalysts)

The composition of the invention further comprises at least one curing agent B2 for epoxy resins, where the curing agent B2 is a dihydrazide selected from the group consisting of glutaric dihydrazide, adipic dihydrazide, pimelic dihydrazide, 8,12-eicosadienedioic acid 1,20-dihydrazide (UDH) and 4-isopropyl-2, 5-dioxoim idazolidine-1,3-di(propionohydrazide) (VDH).

Preference is given to adipic dihydrazide, 8,12-eicosadienedioic acid 1,20-dihydrazide (UDH) and 4-isopropyl-2,5-dioxoim idazolidine-1,3-di(propionohydrazide) (VDH). Most preferred is adipic dihydrazide.

Suitable dihydrazides are commercially available, for example, from Otsuka Chemical Co., Ltd under the Ajicure® trade name (from Ajinomoto Fine-TechnoCo., Inc.) and under the Technicure® trade name (from A&C Catalysts)

It has been found that, surprisingly, other aromatic curing agents for epoxy resins than curing agent B1, alone or in combination with curing agent B2, do not lead to sufficiently high values for lap shear strength (ZSF) in the case of induction preliminary curing at 200° C., especially 180° C. This is apparent, for example, in table 1 and table 2 in the comparison of R3 and R4 with E1-E5.

The weight ratio of curing agent B1 to curing agent B2 (B1/B2) is 0.15-20.

If the weight ratio is less than 0.15, this is disadvantageous in that low values are obtained for ZSF in the case of induction preliminary curing at 180° C., or 200° C. Moreover, low values in tensile strength (ZF), modulus of elasticity, ZSF and Tg are obtained on oven curing. This is apparent, for example, in table 1 and table 2 in the comparison of R2 with E5.

If the weight ratio is more than 20, this is disadvantageous in that low values are obtained for ZSF in the case of induction preliminary curing at 180° C. Moreover, low impact peel (IP) values at 23° C. and −30° C. are obtained on oven curing. This is apparent, for example, in table 1 and table 2 in the comparison of

R5 with E1.

More preferably, the weight ratio of curing agent B1 to curing agent B2 (B1/B2) is 0.3-15, preferably 0.4-10, especially 0.8-8, especially 1.1-6, especially 2-5, especially preferably 3-4. This is advantageous in that high ZSF values are obtained on induction preliminary curing at 200° C., especially 180° C. Moreover, high values for ZF and modulus of elasticity are achieved on oven curing.

It may further be advantageous when the weight ratio of curing agent B1 to curing agent B2 (B1/B2) is 0.3-15, preferably 0.4-10, especially 0.5-5, especially 0.6-3, especially 0.7-2, especially 0.8-1.5, especially preferably 0.9-1.3. This is advantageous in that high ZSF values are obtained on oven curing.

It may also be advantageous when the weight ratio of curing agent B1 to curing agent B2 (B1/B2) is 0.15-8, preferably 0.2-4, especially 0.25-2, especially 0.3-1.5, especially 0.35-1, especially 0.35-0.8, especially preferably 0.35-0.6. This gives high IP values on oven curing.

The ratio of the proportion of epoxy groups of the epoxy resin A in mol/sum total of curing agent B1 and curing agent B2 in mol (A/(B1+B2)) is preferably 3-5, especially 3.5-4.5. This is advantageous in that, within this range, particularly advantageous values are obtained for mechanical properties, lap shear strength, Tg and impact peel of the cured composition, and for the lap shear strength of the precured composition.

It may further be advantageous when more than 80% by weight, preferably more than 90% by weight, especially more than 95% by weight, especially preferably more than 98% by weight, most preferably more than 99% by weight, based on the total weight of the thermosetting one-component epoxy resin composition, comes from the molecules of the curing agents B1 and B2 having hydrazide groups that are present.

It is further advantageous when the thermosetting one-component epoxy resin composition includes a minimum amount of dicyandiamide. If the epoxy resin composition includes dicyandiamide, the weight ratio of the total amount of curing agent B1 and curing agent B2 to dicyandiamide ((B1+B2)/dicyandiamide) is 0.5, 0.75, 1, 2, 5, especially 10, preferably 50, more preferably 100.

The amount of dicyandiamide is preferably less than 5% by weight, less than 3% by weight, less than 2% by weight, especially less than 1% by weight, preferably less than 0.5% by weight, more preferably less than 0.3% by weight, most preferably less than 0.1% by weight, based on the total weight of the epoxy resin composition. More preferably, the thermosetting one-component epoxy resin composition does not include any dicyandiamide.

Preferably, the thermosetting one-component epoxy resin composition additionally contains at least one accelerator C for epoxy resins.

Preferably, the accelerator C for epoxy resins is selected from the list consisting of substituted ureas, imidazoles, imidazolines and blocked amines, especially substituted ureas.

This preferably comprises substituted ureas of the formula (I)

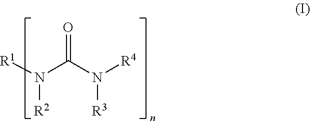

in which R 1 and R 2 are independently hydrogen atoms or monovalent alkyl radicals which have 1 to 10 carbon atoms and optionally also comprise oxygen atoms, nitrogen atoms and/or aromatic units or together form a divalent alkyl radical having 1 to 10 carbon atoms, and which may additionally comprise oxygen atoms, nitrogen atoms or aromatic units; R 3 and R 4 are independently hydrogen atoms or monovalent alkyl radicals which have 1 to 10 carbon atoms and optionally also comprise oxygen atoms or nitrogen atoms; and the index n has a value of 1 or 2.

The substituted urea of the formula (I) is preferably selected from the group consisting of p-chlorophenyl-N,N-dimethylurea (monuron), 3-phenyl-1,1-dimethylurea (fenuron), 3,4-dichlorophenyl-N,N-dimethylurea (diuron), N-methylurea, N,N-dimethylurea, N,N- [symbol] imethylurea, N,N,N [symbol] rimethylurea, N,N,N [symbol] tetramethylurea and derivatives thereof, where some or all methyl groups are instead ethyl groups.

Preferably, R¹ and R² are independently hydrogen atoms or monovalent linear or branched alkyl radicals which have 1 to 10, preferably 1 to 5, more preferably 1 to 4, carbon atoms and optionally together constitute a divalent alkyl radical that forms a ring structure with the adjacent nitrogen atom, and/or R³ and R⁴ independently represent hydrogen atoms or monovalent linear or branched alkyl radicals which have 1 to 10, preferably 1 to 5, more preferably 1 to 4, carbon atoms and optionally together constitute a divalent alkyl radical that forms a ring structure with the adjacent nitrogen atom.

Very particularly preferred substituted ureas of the formula (I) are those in which R¹ and R² in formula (I) are both hydrogen atoms and/or in which R³ and R⁴ are both ethyl or methyl groups, preferably methyl groups.

Further preferred urea derivatives of the formula (I) include those in which R¹ , R² , R³ and R⁴ in formula (I) all represent ethyl or methyl, preferably methyl groups, or in which R¹ , R² and R³ represent ethyl or methyl, preferably methyl, and R⁴ is a hydrogen atom, or where R¹ and R⁴ both represent hydrogen atoms, and R² and R³ both represent ethyl or methyl groups, preferably methyl groups.

Suitable urea derivatives are commercially available, for example, under the Dyhard® trade name (from AlzChem Group AG), under the Omicure® trade name (from CVC Thermoset Specialties), under the Amicure® trade name (from Evonik) and from Sigma Aldrich.

The accelerator C especially has a molecule of less than 1000 g/mol, especially between 80 and 800 g/mol. If the molecular weight is greater, the accelerating effect is reduced and the necessary use amount is significantly higher, which can in turn lead to poor mechanical properties.

The amount of the accelerator C is advantageously 0.01-6.0% by weight, especially 0.02-4.0% by weight, preferably 0.02-2.0% by weight, based on the weight of the epoxy resin A.

The ratio of the proportion of accelerator C in grams per mole of epoxy groups of the epoxy resin A is preferably 0.01-0.5 g/mol of epoxy groups, especially 0.05-0.3 g/mol of epoxy groups, more preferably 0.075-0.2 g/mol of epoxy groups, most preferably 0.08-0.15 g/mol of epoxy groups.

This is advantageous in that this gives higher values for ZSF in the case of induction precuring, and higher values for mechanical properties, ZSF and IP in the case of oven curing. This is apparent, for example, in table 1 and table 2 in the comparison of E2 with E3.

The one-component thermosetting epoxy resin composition preferably comprises at least one toughness improver D. The toughness improvers D may be solid or liquid.

More particularly, the toughness improver D is selected from the group consisting of terminally blocked polyurethane polymers D1, liquid rubbers D2 and core-shell polymers D3. The toughness improver D is preferably selected from the group consisting of terminally blocked polyurethane polymers D1 and liquid rubbers D2. Particular preference is given to a terminally blocked polyurethane polymer D1.

If the toughness improver D is a terminally blocked polyurethane prepolymer D1.

It is preferably a terminally blocked polyurethane polymer D1 blocked with a blocking group that is eliminated at a temperature above 100° C.

Preferred blocking groups are especially firstly phenols or bisphenols. Preferred examples of such phenols and bisphenols are especially phenol, cresol, resorcinol, catechol, cardanol (3-pentadecenylphenol (from cashewnutshell oil)), nonylphenol, phenols that have been reacted with styrene or dicyclopentadiene, bisphenol A, bisphenol F and 2,2 [symbol] iallylbisphenol A.

The terminally blocked polyurethane prepolymer is prepared from a linear or branched polyurethane prepolymer terminated by isocyanate groups with one or more isocyanate-reactive compounds. If two or more such isocyanate-reactive compounds are used, the reaction can be effected sequentially or with a mixture of these compounds.

The reaction is preferably effected in such a way that the one or more isocyanate-reactive compounds are used stoichiometrically or in a stoichiometric excess in order to ensure that all NCO groups have been converted.

The polyurethane prepolymer with isocyanate end groups can be prepared from at least one diisocyanate or triisocyanate and from a polymer Q_{PM} having terminal amino, thiol or hydroxyl groups and/or from an optionally substituted polyphenol Q_{PP}.

Suitable diisocyanates are aliphatic, cycloaliphatic, aromatic or araliphatic diisocyanates, especially commercial products such as methylene diphenyl diisocyanate (MDI), hexamethylene diisocyanate (HDI), toluene diisocyanate (TDI), toluidine diisocyanate (TODD, isophorone diisocyanate (IPDI), trim ethylhexamethylene diisocyanate (TMDI), 2,5- or 2,6-bis(isocyanatomethyl)bicyclo[2.2.1]heptane, naphthalene 1,5-diisocyanate (NDI), dicyclohexylmethyl diisocyanate (H₁₂MDI), p-phenylene diisocyanate (PPDI), m-tetramethylxylylene diisocyanate (TMXDI), etc. and dimers thereof. Preference is given to HDI, IPDI, MDI or TDI.

Suitable triisocyanates are trimers or biurets of aliphatic, cycloaliphatic, aromatic or araliphatic diisocyanates, especially the isocyanurates and biurets of the diisocyanates described in the previous paragraph. It is of course also possible to use suitable mixtures of di- or triisocyanates.

Especially suitable polymers Q_{PM} having terminal amino, thiol or hydroxyl groups are polymers Q_{PM} having two or three terminal amino, thiol or hydroxyl groups.

The polymers Q_{PM} advantageously have an equivalent weight of 300-6000, especially of 600-4000, preferably of 700-2200, g/equivalent of NCO-reactive groups.

Preferred polymers Q_{PM} are polyols having average molecular weights between 600 and 6000 daltons, selected from the group consisting of polyethylene glycols, polypropylene glycols, polyethylene glycol-polypropylene glycol block polymers, polybutylene glycols, hydroxyl-terminated polybutadienes, hydroxyl-terminated butadiene-acrylonitrile copolymers and mixtures thereof.

Especially preferred polymers Q_{PM} are α□w-dihydroxy polyalkylene glycols having C₂ -C₆ -alkylene groups or having mixed C₂ -C₆ -alkylene groups, terminated by amino, thiol or, preferably, hydroxyl groups. Particular preference is given to polypropylene glycols or polybutylene glycols. Particular preference is further given to hydroxyl group-terminated polyoxybutylenes.

Especially suitable polyphenols Q_{PP} are bis-, tris- and tetraphenols. This is understood to mean not just straight phenols but optionally also substituted phenols. The nature of the substitution may be very varied. More particularly, this is understood to mean substitution directly on the aromatic ring to which the phenolic OH group is bonded. Phenols are additionally understood to mean not just monocyclic aromatics but also polycyclic or fused aromatics or heteroaromatics that have the phenolic OH group directly on the aromatic or heteroaromatic system.

In a preferred embodiment, the polyurethane prepolymer is prepared from at least one diisocyanate or triisocyanate and from a polymer Q_{PM} having terminal amino, thiol or hydroxyl groups. The polyurethane prepolymer is prepared in a manner known to the person skilled in the art of polyurethane, especially by using the diisocyanate or triisocyanate in a stoichiometric excess in relation to the amino, thiol or hydroxyl groups of the polymer Q_{PM}.

The polyurethane prepolymer having isocyanate end groups preferably has elastic character. It preferably exhibits a glass transition temperature Tg of less than 0° C.

The toughness improver D may be a liquid rubber D2. This may be, for example, a carboxy- or epoxy-terminated polymer.

In a first embodiment, this liquid rubber may be a carboxy- or epoxy-terminated acrylonitrile/butadiene copolymer or derivative thereof. Such liquid rubbers are commercially available, for example, under the Hypro/Hypox® CTBN and CTBNX and ETBN name from Emerald Performance Materials. Suitable derivatives are especially elastomer-modified prepolymers having epoxy groups, as sold commercially under the Polydis® product line, especially from the Polydis® 36 . . . product line, by Struktol® (Schill+Seilacher Gruppe, Germany) or under the Albipox product line (Evonik, Germany).

In a second embodiment, this liquid rubber may be a polyacrylate liquid rubber which is fully miscible with liquid epoxy resins and separates to form microdroplets only in the course of curing of the epoxy resin matrix. Such polyacrylate liquid rubbers are available, for example, under the 20208-XPA name from Dow.

It is of course also possible to use mixtures of liquid rubbers, especially mixtures of carboxy- or epoxy-terminated acrylonitrile/butadiene copolymers or derivatives thereof.

The toughness improver D, in a third embodiment, may be a core-shell polymer D3. Core-shell polymers consist of an elastic core polymer and a rigid shell polymer. Particularly suitable core-shell polymers consist of a core of elastic acrylate or butadiene polymer encased by a rigid shell of a rigid thermoplastic polymer. This core-shell structure either forms spontaneously as a result of separation of a block copolymer or is defined by the conduct of the polymerization as a latex or suspension polymerization with subsequent grafting. Preferred core-shell polymers are what are called MBS polymers, which are commercially available under the Clearstrength™ trade name from Arkema, Paraloid™ from Dow or F-351™ from Zeon.

Preferably, the proportion of toughness improver D, especially of terminally blocked polyurethane polymer D1, is 15-45% by weight, especially 20-40% by weight, especially 22.5-35% by weight, especially 25-35% by weight, more preferably 27.5-32.5% by weight, based on the total weight of the thermosetting one-component epoxy resin composition.

This is advantageous in that this gives high values for IP with simultaneously high values of ZF, modulus of elasticity and ZSF.

In a further preferred embodiment, the composition additionally comprises at least one filler F. Preference is given here to mica, talc, kaolin, wollastonite, feldspar, syenite, chlorite, bentonite, montmorillonite, calcium carbonate (precipitated or ground), dolomite, quartz, silicas (fused or precipitated), cristobalite, calcium oxide, aluminum hydroxide, magnesium oxide, hollow ceramic beads, hollow glass beads, hollow organic beads, glass beads, color pigments. Particular preference is given to fillers selected from the group consisting of calcium carbonate, calcium oxide and fumed silicas.

Advantageously, the total proportion of the overall filler F is 5-40% by weight, preferably 10-30% by weight, based on the total weight of the thermosetting one-component epoxy resin composition.

In a further preferred embodiment, the composition additionally comprises at least one epoxy-bearing reactive diluent G. Such reactive diluents are known to the person skilled in the art. Preferred examples of epoxy-bearing reactive diluents are:
glycidyl ethers of monofunctional, saturated or unsaturated, branched or unbranched, cyclic or open-chain, C₄ -C₃₀ alcohols, e.g. butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether, and the like;
glycidyl ethers of difunctional, saturated or unsaturated, branched or unbranched, cyclic or open-chain, C₂ -C₃₀ alcohols, e.g. ethylene glycol glycidyl ether, butanediol glycidyl ether, hexanediol glycidyl ether, octanediol glycidyl ether, cyclohexanedimethanol diglycidyl ether, neopentyl glycol diglycidyl ether, and the like;
glycidyl ethers of tri- or polyfunctional, saturated or unsaturated, branched or unbranched, cyclic or open-chain, alcohols, such as epoxidized castor oil, epoxidized trimethylolpropane, epoxidized pentaerythritol or polyglycidyl ethers of aliphatic polyols, such as sorbitol, glycerol, trimethylolpropane, and the like;
glycidyl ethers of phenol compounds and aniline compounds, such as phenyl glycidyl ether, cresyl glycidyl ether, p-tert-butylphenyl glycidyl ether, nonylphenol glycidyl ether, 3-n-pentadecenyl glycidyl ether (from cashewnutshell oil), N,N-diglycidylaniline, and the like;
epoxidized amines, such as N,N-diglycidylcyclohexylamine, and the like;
epoxidized mono- or dicarboxylic acids, such as glycidyl neodecanoate, glycidyl methacrylate, glycidyl benzoate, diglycidyl phthalate, tetrahydrophthalate and hexahydrophthalate, diglycidyl esters of dimeric fatty acids, and the like;
epoxidized di- or trifunctional, low to high molecular weight polyether polyols, such as polyethylene glycol diglycidyl ether, polypropylene glycol diglycidyl ether, and the like.

Particular preference is given to hexanediol diglycidyl ether, cresyl glycidyl ether, p-tert-butylphenyl glycidyl ether, polypropylene glycol diglycidyl ether and polyethylene glycol diglycidyl ether.

Advantageously, the total proportion of the epoxy-bearing reactive diluent G is 0.1-15% by weight, preferably 0.1-5% by weight, especially preferably 0.1-2% by weight, more preferably 0.2-1% by weight, based on the total weight of the thermosetting one-component epoxy resin composition.

The composition may include further constituents, especially catalysts, stabilizers, especially heat and/or light stabilizers, thixotropic agents, plasticizers, solvents, mineral or organic fillers, blowing agents, dyes and pigments, anticorrosives, surfactants, defoamers and adhesion promoters.

Suitable plasticizers are especially phenol alkylsulfonates or N-butylbenzamide, as commercially available as Mesamoll® or Dellatol BBS from Bayer.

Suitable stabilizers are especially optionally substituted phenols such as BHT or Wingstay® T (Elkem), sterically hindered amines or N-oxyl compounds such as TEMPO (Evonik).

A particularly preferred one-component epoxy resin composition comprises:
10-60% by weight, especially 30-60% by weight, based on the total weight of the epoxy resin composition, of epoxy resin A having an average of more than one epoxy group per molecule; preferably 50-100% by weight, especially 80-100% by weight, of the epoxy resin A is a liquid epoxy resin and 0-30% by weight, especially 0-20% by weight, of the epoxy resin A is a solid epoxy resin;
at least one curing agent B1 for epoxy resins, where the curing agent B1 is an aromatic dicarboxylic dihydrazide, especially isophthalic dihydrazide and/or terephthalic dihydrazide, preferably isophthalic dihydrazide;
at least one curing agent B2 for epoxy resins, where the curing agent B2 is a dihydrazide selected from the group consisting of glutaric dihydrazide, adipic dihydrazide, pimelic dihydrazide, 8,12-eicosadienedioic acid 1,20-dihydrazide and 4-isopropyl-2,5-dioxoimidazolidine-1,3-di(propionohydrazide), especially adipic dihydrazide, 8,12-eicosadienedioic acid 1,20-dihydrazide and 4-isopropyl-2,5-dioxoimidazolidine-1,3-di(propionohydrazide), most preferably adipic dihydrazide;
preferably 0.01-6.0 wt %, especially 0.02-4.0 wt %, preferably 0.02-2.0 wt %, based on the weight of the epoxy resin A, of at least one accelerator C for epoxy resins selected from the list consisting of substituted ureas, imidazoles, imidazolines and blocked amines, especially substituted ureas;
preferably 15-45% by weight, especially 20-40% by weight, especially 22.5-35% by weight, especially 25-35% by weight, particularly preferably 27.5-32.5% by weight, based on the total weight of the thermosetting one-component epoxy resin composition, of at least one toughness improver D which is selected from the group consisting of terminally blocked polyurethane polymers D1, liquid rubbers D2 and core-shell polymers D3, preferably terminally blocked polyurethane polymers D1;
preferably 5-40% by weight, preferably 10-30% by weight, based on the total weight of the thermosetting one-component epoxy resin composition, of a filler F selected from the group consisting of calcium carbonate, calcium oxide and fumed silicas;
preferably 0.1-15% by weight, preferably 0.1-5% by weight, especially preferably 0.1-2% by weight, more preferably 0.2-1% by weight, based on the total weight of the thermosetting one-component epoxy resin composition, of an epoxy-bearing reactive diluent G.

The weight ratio of curing agent B1 to curing agent B2 (B1/B2) is 0.15-20, preferably 0.3-15, preferably 0.4-10, especially 0.8-8, especially 1.1-6, especially 2-5, especially preferably 3-4.

The ratio of the proportion of epoxy groups of the epoxy resin A in mol/sum total of curing agent B1 and curing agent B2 in mol (A/(B1+B2)) is preferably 3-5, especially 3.5-4.5.

The ratio of the proportion of accelerator C in grams per mole of epoxy groups of the epoxy resin A is preferably 0.01-0.5 g/mol of epoxy groups, especially 0.05-0.3 g/mol of epoxy groups, more preferably 0.075-0.2 g/mol of epoxy groups, most preferably 0.08-0.15 g/mol of epoxy groups.

It may further be advantageous when the preferred one-component epoxy resin composition consists of the aforementioned constituents to an extent of more than 80% by weight, preferably more than 90% by weight, especially more than 95% by weight, especially preferably more than 98% by weight, most preferably more than 99% by weight, based on the total weight of the epoxy resin composition.

Examples of particularly preferred compositions are E2 and E7, especially E7, in table 1.

It is advantageous when the epoxy resin composition of the invention has a viscosity at 25° C. of 500-3500 Pa*s, especially 1000-3000 Pa*s, preferably 1500-2500 Pa*s, more preferably 2000-2500 Pa*s, especially measured with a rheometer in oscillation using a plate-plate geometry with the following parameters: 5 Hz, measurement gap 1 mm, plate-plate diameter 25 mm, 1% deformation. This is advantageous in that this assures good applicability.

It has been found that the thermosetting one-component epoxy resin compositions described are particularly suitable for use as one-component thermosetting adhesives, especially as a thermosetting one-component bodywork adhesive in motor vehicle construction. Such a one-component adhesive has a range of possible uses. Such adhesives are required for the bonding of heat-stable materials. Heat-stable materials are understood to mean materials which are dimensionally stable at a curing temperature of 100-220° C., preferably 120-200° C., at least during the curing time. In particular, these are metals and plastics, such as ABS, polyamide, polyphenylene ether, composite materials, such as SMC, unsaturated polyesters GFP, epoxy or acrylate composite materials. Preference is given to the use in which at least one material is a metal. A particularly preferred use is considered to be the bonding of identical or different metals, especially in bodywork construction in the automobile industry. The preferred metals are in particular steel, especially electrolytically galvanized, hot-dip-galvanized or oiled steel, Bonazinc-coated steel, and post-phosphated steel, and also aluminum, especially in the variants which typically occur in automobile construction.

With an adhesive based on a thermosetting one-component composition of the invention, it is possible without additional metal joining techniques after preliminary curing, especially 30-60 seconds at 180-200° C., preferably 180° C., in the case of further heating to 180° C., to assure sufficient adhesion of the bonded substrates.

Such an adhesive is used especially in applications that do not use any metal joining techniques, especially thermal and mechanical metal joining techniques, more preferably welding and riveting. These applications preferably first comprise precuring of the adhesive, especially 60 seconds at 180-200° C., preferably 180° C., and subsequently, especially after cooling of the precured adhesive to below 60° C., further heating to at least 160° C., especially at least 180° C., and subsequent complete curing of the adhesive.

Such an adhesive is especially contacted first with the materials to be bonded at a temperature of between 10° C. and 80° C., especially between 10° C. and 60° C., then precured and later fully cured as described above.

A further aspect of the present invention relates to a process for the bonding of heat-stable substrates, which comprises the stages:
i) applying a thermosetting one-component epoxy resin composition as described in detail above to the surface of a heat-stable substrate especially of a metal;
ii) contacting the thermosetting one-component epoxy resin composition applied with the surface of a further heat-stable substrate S2, especially of a metal;
iii) heating the composition to a temperature of 160-220° C., especially of 170-200° C., preferably of 175-190° C., for 10-120 seconds, especially for 20-80 seconds, preferably for 30-60 seconds,
iv) heating the composition to a temperature of 100-220° C., especially of 120-200° C., preferably between 140 and 190° C., more preferably between 150 and 180° C.; where the composition reaches a temperature between step iii) and step iv) of less than 100° C., especially less than 60° C., preferably 50-20° C. Preferably, there is a period of time between step iii) and step iv) of more than 15 minutes, especially more than 20 minutes, preferably 30 minutes, especially 30 to 300 minutes.

The substrate S2 consists here of the same material as or a different material from the substrate St The substrates S1 and/or S2 are in particular the aforementioned metals and plastics.

Preferably, the heating in step iii) is heating by induction.

Preferably, in step iv), the composition is heated to a temperature of 100-220° C., especially of 120-200° C., preferably between 140 and 190° C., more preferably between 150 and 180° C., and the composition is left at the aforementioned temperature for 10 min-6 h, 10 min-2 h, 10 min-60 min, 10 min-30 min, 10 min-20 min, more preferably 10 min-15 min.

Such a method of bonding heat-stable materials results in an adhesive-bonded article. Such an article is preferably a vehicle or part of a vehicle.

A further aspect of the present invention accordingly relates to an adhesive-bonded article obtained from the abovementioned process. Furthermore, the compositions according to the invention are suitable not only for automobile construction but also for other fields of use. Particular mention should be made of related applications in the construction of transportation means, such as ships, trucks, buses or rail vehicles, or in the construction of consumer goods, such as, for example, washing machines.

The materials adhesive-bonded by means of a composition according to the invention are used at temperatures between typically 120° C. and −40° C., preferably between 100° C. and −40° C., in particular between 80° C. and −40° C.

A particularly preferred use of the thermosetting one-component epoxy resin composition of the invention is the use thereof as a thermosetting one-component bodywork adhesive in motor vehicle construction or as a stiffening compound or as a foamable, thermosetting composition for the reinforcement of voids in structural components and reinforcing elements.

A further aspect of the present invention relates to a cured epoxy resin composition as obtained by heating a thermosetting one-component epoxy resin composition as described in detail above.

More preferably, the compositions of the invention have the following properties:

### After Preliminary Curing for 35 Seconds at 180° C.

ZSF, measured as described in the experimental at a temperature of 180° C., of ≥2.3 MPa, especially ≥2.4 MPa, especially ≥2.6 MPa, especially ≥2.9 MPa, more preferably ≥3 MPa,

and/or

### After Full Curing for 40 Minutes at 180° C.

ZF, measured as described in the experimental, of 30 MPa, especially MPa, especially 40 MPa;

Elongation at break (BD), measured as described in the experimental, 5-20%;

Modulus of elasticity, measured as described in the experimental, of ≥1000 MPa, especially ≥1250 MPa, especially ≥1500 MPa, more preferably ≥1750 MPa;

Tg, measured as described in the experimental, of ≥130° C., especially ≥140° C., especially ≥150° C., more preferably ≥160° C.;

ZSF, measured as described in the experimental, of ≥30 MPa, especially ≥31 MPa, especially ≥32 MPa, more preferably ≥33 MPa;

IP at 23° C., measured as described in the experimental, of ≥16 N/mm, especially ≥18 N/mm, especially ≥20 N/mm, more preferably ≥22 N/mm;

IP at −30° C., measured as described in the experimental, of ≥7 N/mm, especially ≥10 N/mm, more preferably ≥15 N/mm.

### EXAMPLES

Adduced hereinafter are some examples which further illustrate the invention, but which are not intended to restrict the scope of the invention in any way.

### Preparation of a Toughness Improver (“D-1”)

150 g of poly-THF 2000 (OH number 57 mg/g KOH) and 150 of Liquiflex H (OH number 46 mg/g KOH) were dried under reduced pressure at 105° C. for 30 minutes. Once the temperature had been reduced to 90° C., 61.5 g of IPDI and 0.14 g of dibutyltin dilaurate were added. The reaction was carried out under vacuum at 90° C. until the NCO content was constant at 3.10% after 2.0 h (calculated NCO content: 3.15%). Subsequently, 96.1 g of cardanol was added as blocking agent. Stirring was continued at 105° C. under vacuum until it was no longer possible to detect any free NCO. The product was used as such as toughness improver D-1.

| | |
|---|---|
| A- | liquid epoxy resin, D.E.R. 331 (bisphenol A diglycidyl ether), |
| Liquid | Dow |
| resin | |
| RD | Reactive diluent, hexanediol glycidyl ether, Denacol EX-212, |
| | Nagase America |
| ADH | adipic dihydrazide, Technicure ADH-J, A&C Catalysts Inc. |
| IDH | isophthalic dihydrazide, Technicure IDH-J, A&C Catalysts Inc. |
| DDS | 3,3 [symbol] Ediaminodiphenylsulfone, Aradur-9719-1, Huntsman |
| C1 | N,N-dimethylurea (=1,1-dimethylurea), n = 1, R¹ = H, R² = |
| | R³ = CH₃, Sigma-Aldrich, Switzerland |
| Dicy | dicyandiamide, Dyhard 100SF, AlzChem |
| Filler | Mixture of calcium carbonate, calcium oxide, fumed silica |
| | Poly-THF 2000 (difunctional polybutylene glycol) |
| | (OH equivalent weight = about 1000 g/OH equivalent), BASF |
| | Liquiflex H (hydroxyl-terminated polybutadiene) |
| | (OH equivalent weight = about 1230 g/OH equivalent), Krahn |
| | Isophorone diisocyanate (=“IPDI”), Evonik |
| | Cardolite NC-700 (cardanol, meta-substituted |
| | alkenylmonophenol), Cardolite |

Raw materials used.

### Production of the Compositions

The reference compositions R1-R5 and the inventive compositions E1 to E8 were produced according to the figures in table 1. The stated amounts in table 1 are in parts by weight.

The ratio of the proportion of epoxy groups in the epoxy resin A in mol/sum total of curing agent B1 and curing agent B2 in mol (A/(B1+B2)) is called “DH index” in table 1 and is reported in [mol EP groups/mol (B1+B2)].

The ratio of the proportion of accelerator C in grams per mole of epoxy groups of the epoxy resin A is called “C index” in table 1 and reported in [g of accelerator/mol of EP groups].

The weight ratio of curing agent B1 to curing agent B2 is reported in table 1 as “(B1/B2)”.

Test methods:

### Tensile Strength, Elongation at Break and Modulus of Elasticity (DIN EN ISO 527)

An adhesive sample was pressed between two Teflon papers to a layer thickness of 2 mm. After curing at 180° C. for 40 min, the Teflon papers were removed and the specimens were die-cut to the DIN standard state. The test specimens were examined under standard climatic conditions at a strain rate of 2 mm/min. Tensile strength (ZF), elongation at break and the 0.05-0.25% modulus of elasticity were measured to DIN EN ISO 527 at a temperature of 23° C.

### Lap Shear Strength (ZSF) (DIN EN 1465), Curing IV (Inductive Preliminary Curing), Tmax 180° C./200° C.

Cleaned test specimens of Elo H420 steel (thickness 1.5 mm) that had been reoiled with Anticorit PL 3802-39S were bonded with the adhesive over a bonding area of 25×10 mm with glass beads as spacer in a layer thickness of 0.3 mm. Thereafter, the samples are heated by induction (EW2 laboratory induction system, manufacturer: IFF GmbH Deutschland) to a temperature of 180° C., or 200° C., within 10 seconds, and left at a temperature of 180° C., or 200° C., for 35 seconds. Thereafter, the samples were brought to a temperature of 150° C. by means of compressed air within 10 seconds, and then the samples were left to cool to 23° C.

Lap shear strength was determined using a tensile tester at a strain rate of 10 mm/min in a triple determination to DIN EN 1465 at a temperature of 23° C. (“ZSF@23° C. [MPa]”), or at a temperature of 180° C. (“ZSF@180° C. [MPa]”).

### Lap Shear Strength (ZSF) (DIN EN 1465), OH Curing (Oven Curing) (40 min/180° C.)

Cleaned test specimens of Elo H420 steel (thickness 1.5 mm) that had been reoiled with Anticorit PL 3802-39S were bonded with the adhesive over a bonding area of 25×10 mm with glass beads as spacer in a layer thickness of 0.3 mm, and cured at oven temperature 140° C. for 10 min. Lap shear strength was determined on a tensile tester at a strain rate of 10 mm/min in a triple determination to DIN EN 1465 at a temperature of 23° C.

### Impact Peel Strength (IP 23° C./−30 ° C.) (to ISO 11343)

The specimens were produced with the adhesive and DC04+ZE steel with dimensions of 90×20×0.8 mm. The bonding area here was 20×30 mm at a layer thickness of 0.3 mm with glass beads as spacer. The samples were cured for 10 minutes at oven temperature 140° C. Impact peel strength was measured at 23° C., or at −30° C., as a triple determination on a Zwick 450 impact pendulum. The impact peel strength reported is the average force in N/mm under the measurement curve from 25% to 90% to IS011343.

### Viscosity

Viscosity measurements of the adhesives were effected 1 d after production on an Anton Paar MCR 101 rheometer by oscillation using a plate-plate geometry at a temperature of 25° C. with the following parameters: 5 Hz, measurement gap 1 mm, plate-plate diameter 25 mm, 1% deformation. The analyzed compositions R1-R5 and E1 to E8 all had a viscosity of 1500-2500 Pa*s.

TABLE 1

| | R1 | R2 | R3 | R4 | R5 | E1 | E2 | E3 | E4 | E5 | E6 | E2 | E7 | E8 |
|---|---|---|---|---|---|---|---|---|---|---|---|---|---|---|
| A- | 52.2 | 48.3 | 46.0 | 46.6 | 47.6 | 47.7 | 47.8 | 47.9 | 47.9 | 48.1 | 51.6 | 47.8 | 43.9 | 35.9 |
| Liquid | | | | | | | | | | | | | | |
| resin | | | | | | | | | | | | | | |
| RD | 0.9 | 0.9 | 0.8 | 0.9 | 0.9 | 0.9 | 0.9 | 0.9 | 0.9 | 0.9 | 0.9 | 0.9 | 0.9 | 0.9 |
| D1 | 23.9 | 22.1 | 21.1 | 21.4 | 21.9 | 21.9 | 21.9 | 21.9 | 22.0 | 22.1 | 17.3 | 21.9 | 26.6 | 36.3 |
| Dicy | 4.4 | | | | | | | | | | | | | |
| IDH | | | | | 12.68 | 11.42 | 9.53 | 9.55 | 6.38 | 3.20 | 10.28 | 9.53 | 8.77 | 7.19 |
| ADH | | 11.52 | | 2.78 | | 1.14 | 2.85 | 2.86 | 5.72 | 8.61 | 3.08 | 2.85 | 2.63 | 2.15 |
| DDS | | | 15.65 | 11.88 | | | | | | | | | | |
| C1 | 0.23 | 0.21 | 0.2 | 0.21 | 0.21 | 0.21 | 0.21 | — | 0.21 | 0.21 | 0.23 | 0.21 | 0.2 | 0.15 |
| Fillers | 18.37 | 16.97 | 16.25 | 16.23 | 16.71 | 16.73 | 16.81 | 16.89 | 16.89 | 16.88 | 16.61 | 16.81 | 17 | 17.41 |
| Sum: | 100 | 100 | 100 | 100 | 100 | 100 | 100 | 100 | 100 | 100 | 100 | 100 | 100 | 100 |
| (B1/B2) | | | | | | 10.0 | 3.3 | 3.3 | 1.1 | 0.4 | 3.3 | 3.3 | 3.3 | 3.3 |
| DH | 5.5 | 4 | 4 | 4 | 4 | 4 | 4 | 4 | 4 | 4 | 4 | 4 | 4 | 4 |
| index | | | | | | | | | | | | | | |
| C index | 0.8 | 0.8 | 0.8 | 0.8 | 0.8 | 0.8 | 0.8 | — | 0.8 | 0.8 | 0.8 | 0.8 | 0.8 | 0.8 |

TABLE 2

| | R1 | R2 | R3 | R4 | R5 | E1 | E2 | E3 | E4 | E5 | E6 | E2 | E7 | E8 |
|---|---|---|---|---|---|---|---|---|---|---|---|---|---|---|
| IV, Tmax | | | | | | | | | | | | | | |
| 180° C. | | | | | | | | | | | | | | |
| ZSF @ 23° | 8.60 | 26.40 | 0 | 3.90 | 22.40 | 27.50 | 26.50 | 9.40 | 24.70 | 24.80 | 27.70 | 26.50 | 23.60 | 15.60 |
| C. [MPa] | | | | | | | | | | | | | | |
| ZSF @ 180° | 1.60 | 2.43 | 0 | 0.18 | 4.47 | 3.80 | 3.80 | 3.00 | 2.46 | 2.70 | 3.30 | 3.80 | 2.84 | 2.33 |
| C. [MPa] | | | | | | | | | | | | | | |
| IV, Tmax | | | | | | | | | | | | | | |
| 200° C. | | | | | | | | | | | | | | |
| ZSF @ 23° | 0.00 | 10.80 | 0 | 2.30 | 0.70 | 6.87 | 14.10 | 2.32 | 16.20 | 16.30 | 17.20 | 14.10 | 13.20 | 4.35 |
| C. [MPa] | | | | | | | | | | | | | | |
| ZSF @ 180° | 0.00 | 2.30 | 0 | 0.40 | 0.00 | 2.92 | 3.19 | 2.69 | 2.92 | 2.44 | 3.56 | 3.19 | 3.00 | 2.33 |
| C. [MPa] | | | | | | | | | | | | | | |
| OH (40 min/ | | | | | | | | | | | | | | |
| 180° C.) | | | | | | | | | | | | | | |
| ZF [MPa] | 30 | 34.20 | 30 | 36 | 46 | 45 | 43 | 21 | 37 | 38 | 47 | 43 | 34 | 24 |
| BD [%] | 10% | 6% | 7% | 8% | 6% | 6% | 6% | 4% | 6% | 6% | 5% | 6% | 8% | 18% |
| Modulus of | 1330 | 1520 | 1480 | 1650 | 2061 | 1846 | 2054 | 1222 | 1697 | 1820 | 2144 | 2054 | 1487 | 860 |
| elasticity | | | | | | | | | | | | | | |
| [MPa] | | | | | | | | | | | | | | |
| Tg DMTA | 118 | 124 | 121 | 121 | 151 | 150 | 145 | 165 | 138 | 130 | 150 | 145 | 142 | 131 |
| [° C.] | | | | | | | | | | | | | | |
| ZSF 23° C. | 32.8 | 33.8 | 29.5 | 32.7 | 32.20 | 31.60 | 33.20 | 26.70 | 33.70 | 32.50 | 32.90 | 33.20 | 31.00 | 25.30 |
| [MPa] | | | | | | | | | | | | | | |
| IP 23° C. | 40.8 | 26.6 | 25.8 | 28.5 | 15.5 | 16.2 | 18.02 | 9.5 | 20.7 | 22.7 | 13.9 | 18.02 | 22.7 | 30.1 |
| [N/mm] | | | | | | | | | | | | | | |
| IP −30° C. | 33.6 | 17.4 | 13.3 | 12.6 | 5.2 | 6.8 | 8.7 | 7.2 | 12.4 | 15.3 | 4.4 | 8.7 | 15.1 | 31.3 |
| [N/mm] | | | | | | | | | | | | | | |

1. A thermosetting one-component epoxy resin composition comprising
a) at least one epoxy resin A having an average of more than one epoxy group per molecule;
b) at least one curing agent B1 for epoxy resins, where the curing agent B1 is an aromatic dicarboxylic dihydrazide; and
c) at least one curing agent B2 for epoxy resins, where the curing agent B2 is a dihydrazide selected from the group consisting of glutaric dihydrazide, adipic dihydrazide, pimelic dihydrazide, 8,12-eicosadienedioic acid 1,20-dihydrazide and 4-isopropyl-2,5-dioxoimidazolidine-1,3-di(propionohydrazide), and
where the weight ratio of curing agent B1 to curing agent B2 (B1/B2) is 0.15-20.

2. The thermosetting one-component epoxy resin composition as claimed in claim 1, wherein the weight ratio of curing agent B1 to curing agent B2 (B1/B2) is 0.3-15.

3. The thermosetting one-component epoxy resin composition as claimed in claim 1, wherein the ratio of the proportion of epoxy groups of the epoxy resin A in mol/proportion of curing agent B1 and curing agent B2 in mol (A/(B1+B2)) is 3-5.

4. The thermosetting one-component epoxy resin composition as claimed in claim 1, wherein the thermosetting one-component epoxy resin composition additionally includes at least one accelerator C selected from the list consisting of substituted ureas, imidazoles, imidazolines and blocked amines, especially substituted ureas.amines.

5. The thermosetting one-component epoxy resin composition as claimed in claim 4, wherein the ratio of the proportion of accelerator C in grams per mole of epoxy groups of the epoxy resin A is 0.01-0.5 g/mol of epoxy groups.

6. The thermosetting one-component epoxy resin composition as claimed in claim 1, wherein the thermosetting one-component epoxy resin composition additionally includes at least one toughness improver D selected from the group consisting of terminally blocked polyurethane polymers D1, liquid rubbers D2 and core-shell polymers D3.

7. The thermosetting one-component epoxy resin composition as claimed in claim 6, wherein the proportion of the at least one toughness improver D is 15-45% by weight, based on the total weight of the thermosetting one-component epoxy resin composition.

8. The thermosetting one-component epoxy resin composition as claimed in claim 1, wherein the thermosetting one-component epoxy resin composition has a viscosity at 25° C. of 500-3000 Pa*s, measured with a rheometer in oscillation using a plate-plate geometry with the following parameters: 5 Hz, measurement gap 1 mm, plate-plate diameter 25 mm, 1% deformation.

9. The thermosetting one-component epoxy resin composition as claimed in claim 1, wherein the proportion of the epoxy resin A is 10-60% by weight, based on the total weight of the thermosetting one-component epoxy resin composition.

10. (canceled)

11. A method of bonding heat-stable substrates, comprising the steps of
i) applying a thermosetting one-component epoxy resin composition as claimed in claim 1 to the surface of a heat-stable substrate S1;
ii) contacting the thermosetting epoxy resin composition applied with the surface of a further heat-stable substrate S2;
iii) heating the composition to a temperature of 160-220° C. for 10-120 seconds,
iv) heating the composition to a temperature of 100-220° C., where the composition reaches a temperature between step iii) and step iv) of less than 100° C.;
in which the substrate S2 consists of the same material as or a different material from the substrate S1.

12. The method as claimed in claim 11, wherein there is a period of time between step iii) and step iv) of more than 15 minutes.

13. The method as claimed in claim 11, wherein the heating in step iii) is heating by induction.

14. The method as claimed in claim 11, wherein, in step iv) of heating the composition to a temperature of 100-220° C., the composition is left at the aforementioned temperature for 10 min-6 h, 10 min-2 h, 10 min -60 min, 10 min-30 min, 10 min-20 min.

15. An adhesive-bonded article obtained from a process as claimed in claim 11.
